(19) United States
(12) Patent Application Publication
(10) Pub. No.: US 2020/0094301 A1
(43) Pub. Date: Mar. 26, 2020

(54) Heat-Enhanced Treatment Of Energetic Compounds In Contaminated Soil, Sediment And/Or Water

(71) Applicant: CDM Smith Inc., Boston, MA (US)

(72) Inventors: Tamzen W. Macbeth, Pocatello, ID (US); Malcolm B. Burbank, Pullman, WA (US)

(21) Appl. No.: 16/583,974

(22) Filed: Sep. 26, 2019

Related U.S. Application Data
(60) Provisional application No. 62/736,896, filed on Sep. 26, 2018.

(51) Int. Cl. B09C 1/00; B09C 1/08; B09C 1/06; C02F 1/02; C02F 1/68

(52) U.S. Cl. CPC B09C 1/002; B09C 1/08; B09C 1/06; C02F 2103/06; C02F 1/68; B09C 2101/00; C02F 1/02

(57) ABSTRACT

Methods of treating matter from a contaminated site in need of decontamination are provided. These methods typically include applying an amendment containing a stimulant to the matter, and actively heating the matter in a controlled manner such that the matter has a temperature above ambient and below 100° C.

### RELATED APPLICATION

This application claims the benefit of U.S. Provisional Application No. 62/736,896, filed on Sep. 26, 2018. The entire teachings of the above application are incorporated herein by reference.

### BACKGROUND

Contamination of soil, sediment and water with energetic compounds is a world-wide problem that poses a serious threat to the health of humans, livestock, wildlife and entire ecosystems. It has been estimated that in the United States alone there are hundreds of contaminated sites. Residual energetics (i.e., free product) in soil and/or sediments released from operating gun ranges, former munitions manufacturing areas, storage and/or transportation/staging areas, hand grenade range, open burn/open detonation, blow in place facilities and formerly used defense sites can also act as long-term sources of contamination to surface water and groundwater.

There is a need for improved methods of treating soil, sediment and water in need of decontamination.

### SUMMARY

The methods of treating soil, water, and/or sediment (typically, matter from a contaminated site) disclosed herein, have a number of significant advantages over previously used methods, including that they allow for high-rate and high-performance decontamination. For example, it has been surprisingly found that even soil contaminated with multiple energetic compounds such as RDX (1,3,5-trinitro-1,3,5-triazinane) and HMX (1,3,5,7-tetranitro-1,3,5,7-tetrazocane), can be rapidly decontaminated with very high degradation rates and degradation percentages.

In one embodiment, the method of treating matter from a contaminated site in need of decontamination includes (i) applying an amendment containing a stimulant to the matter, and (ii) actively heating the matter in a controlled manner such that the matter has a temperature above ambient and below 100° C., wherein the matter is contaminated with one or more energetic compounds.

### BRIEF DESCRIPTION OF THE DRAWINGS

The foregoing will be apparent from the following more particular description of embodiments and the accompanying drawings.

FIGS. 1A and 1B are photos of two different meso-scale microcosms with RDX and HMX-spiked soils. FIG. 1A shows a control soil microcosm. FIG. 1B shows a biostimulated soil microcosm.

FIG. 2 provides a graph showing the mass balance of RDX leached from the microcosms, remaining in soil post-treatment and degraded over the course of the testing.

FIG. 3 provides a graph showing the mass balance of HMX leached from the microcosms, remaining in soil post-treatment and degraded over the course of the testing.

FIG. 4 provides a graph illustrating the measured soil pH for different treatments and different dates of application; the dates of the maintenance applications being each one week apart.

### DETAILED DESCRIPTION

A description of embodiments follows.

Methods for treating matter from a contaminated site in need of decontamination are disclosed. For example, an in situ treatment process, the heat-enhanced treatment of energetic compounds (HETEC) process, has been developed to treat energetic compounds using enhanced biotic and abiotic degradation for high-rate, in situ treatment of contaminated soil, sediment and water. The technology relies on heating (typically <100° C.) and application of amendments to enhance in situ destruction of energetic compounds. In embodiments, in situ treatments include permeation and/or injection of amendment solutions or suspensions of carbon, urea, nutrients, surfactants (e.g., Tween® 20) and shear-thinning polymer (e.g., xanthan gum) into the vadose and saturated zone of the source area that stimulate chemical mass transfer and degradation through a variety of biotic and abiotic pathways. The in situ destruction is believed to result from stimulating energetic compound-degrading microorganisms (including Bacteria, Archaea and/or Fungi) to treat energetic compounds by in situ destruction through a variety of biotic and abiotic pathways.

The methods of treating disclosed herein can enhance mass transfer (dissolution and desorption) of chemicals from source mass (e.g. energetic solid particles), sediment and/or soil to the aqueous phase where it is available for degradation reactions, and, thus, stimulate degradation.

The methods of treating disclosed herein typically include permeation and/or injection of amendment solutions (e.g., of carbon, urea, nutrients, and shear-thinning polymer (e.g., xanthan gum, guar gum, alginate, or SlurryPro™) and/or reduced (ferrous or zero valent) iron) into the vadose and saturated zone of the source area that stimulate chemical degradation through a variety of biotic and abiotic pathways.

The methods of treating disclosed herein typically establish multiple biotic and abiotic degradation mechanisms for efficient degradation to maximize the chemical gradients and enhance dissolution, desorption and diffusion.

The methods of treating disclosed herein use heat which both enhances the mass transfer rate through accelerated dissolution, desorption and diffusion and increases biotic and abiotic degradation rates.

A first embodiment is a method for treating matter from a contaminated site in need of decontamination, comprising (i) applying an amendment containing a stimulant to the matter, and (ii) actively heating the matter in a controlled manner such that the matter has a temperature above ambient and below 100° C., wherein the matter is contaminated with one or more energetic compounds. An alternative first embodiment is a method for treating matter containing one or more energetic compounds, comprising (i) applying an amendment containing a stimulant to the matter, and (ii) actively heating the matter in a controlled manner such that the matter has an increased temperature which is below 100° C.

As used herein, “treat”, “treatment” or “treating” refers to acts that result in the reduction or removal of one or more energetic compounds through biotic and/or abiotic processes.

As used herein, “contaminated site” refers to a site contaminated with one or more energetic compounds. For example, a contaminated site can be an operating gun or shooting range, a former munitions manufacturing area, a storage and/or transportation/staging area, a hand grenade range, an open burn/open detonation area, a blow in place facility, and a formerly used defense sites.

As used herein, “matter from a contaminated site” refers to soil, water or sediment in place at the contaminated site (typically, at the surface, vadose, or saturated zones) or taken from a contaminated site, for example, for decontamination at a different site.

As used herein, matter from a contaminated site “in need of decontamination”, refers to soil, water or sediment which has been determined to contain one or more energetic compounds and in need of removal or reduction of at least one of those energetic compounds.

As used herein, an “energetic compound” refers to a compound with high amount of stored chemical energy that can be released, for example, by combustion, detonation, or explosion. Energetic compounds can be found, for example, in explosives, propellants and ignition compounds.

Energetic compounds that can be degraded with embodiments of the methods disclosed here, include, but are not limited to explosives, ignition compounds (i.e., primers), and propellants.

An explosive can be, but is not limited to, 2,4,6-trinitrotoluene (TNT), 1,3,5-trinitro-1,3,5-triazinane (RDX), 1,3,5,7-tetranitro-1,3,5,7-tetrazocane (HMX), 1,3,5-trinitrobenzene (TNB), 1,3,5-triamino-2,4,6-trinitrobenzene (TATB), diazonitrophenol, nitroguanidine (NQ), 2,4-dinitroanisole (DNAN), tetryl and ammonium picrate (PA, AP), hexanitrohexaazaisowurtzitane (CL20), lead azide, diazodinitrophenol (DDNP), lead styphnate, tetracene, potassium dinitrobenzofuroxane (KDNBF), and lead mononitroresorcinate (LMNR).

As used herein, an “ignition compound” is a chemical compound which assists, supports, or causes combustion of other chemical compounds such as propellants and explosives. An ignition compound can be, but is not limited to, a fulminate, diazonitrophenol (DDNP), a lead azide, a mercury styphnate, a lead styphnate, a silver styphnate, potassium dinotrobenzofuroxane (KDNBF), lead mononitroresorcinate (LMNR), and pentaerythritol tetranitrate (PETN).

A propellant can be, but is not limited to, 2,4-dinitrotoluene (DNT), 2,5-dinitrotoluene, 3,5-dinitrotoluene, 2,6-dinitrotoluene, 2-amino-4,6-dinitrotoluene, 4-amino-2,6-dinitrotoluene, methyl-2,4,6-trinitrophenyl nitramine (Tetryl), dinitroaniline, nitroglycerin (NG), nitrocellulose (NC), nitroguanidine, ammonium perchlorate, and potassium perchlorate.

As used herein, an “amendment” is a solution and/or suspension.

As used herein, “actively heating” refers to transferring heat or energy to raise or maintain the temperature of the matter; it does not include self-heating, for example, as a result of biotic or abiotic processes (e.g., as it occurs during composting).

As used herein, “heating . . . in a controlled manner” refers to heating to a desired temperature and at a desired rate (including maintaining the temperature), wherein the controlling can include measuring, determining, and/or monitoring the temperature and taking actions such as increasing, maintaining, or decreasing heat or energy transfer.

As used herein, “temperature” refers to a temperature that is determined (e.g., through direct or indirect measurement and/or calculation (including modelling)) which represents the temperature of the matter to be decontaminated, for example, for in situ applications, at one location within the soil, water, or sediment to be decontaminated.

In embodiments of the method of treating, heating can be performed using methods and technology known to the person in the art, such as, for example, electrical resistance heating, thermal conduction heating, hot water heating, steam injection, and hot water flushing.

In embodiments of the method of treating, the soil, water, or sediment to be decontaminated is typically heated to a temperature above ambient and below 100° C.

As used herein, “ambient” refers to the air temperature in the location of the matter from a contaminated site in need of decontamination.

In embodiments of the method of treating, the matter is actively heated to a temperature above the temperature of the matter before treatment. Typically, in the methods of treating disclosed herein, the actively heating of the matter in a controlled manner is performed such that the matter reaches a temperature equal to or above 30° C. and below 100° C., equal to or above 30° C. and below 80° C., equal to or above 35° C. and below 80° C., equal to or above 35° C. and below 75° C., equal to or above 40° C. and below 100° C., equal to or above 40° C. and below 80° C., equal to or above 40° C. and below 70° C., equal to or above 40° C. and below 60° C., or equal to or above 50° C. and below 80° C.

As used herein, a “stimulant” is a compound or composition capable of enhancing metabolic and/or physiological processes of an energetic compound degrading bacteria, archaea or fungi and enhancing abiotic chemical degradation. Suitable stimulants include, but are not limited to, carbon and energy sources such as volatile fatty acids (acetate [sodium acetate, potassium acetate, etc], propionate, butyrate, lactate), hydroxybenzoate, mono and disaccharides (glucose, fructose, sucrose, lactose and others), protein based carbon (yeast extract, corn steep liquor, dehydrated meat, etc), cellobiose, cellulose, amino acids, benzoate, molasses, whey, oils (e.g. vegetable oil), methane, ethane, ethene, hydrocarbons, nutrient broth/tryptone (and other commercial nutrient compounds), biopolymers (chitin, lignin, starches, polysaccharides), alcohols (e.g. ethanol, methanol), sugar alcohols (including glycerol, sorbitol, mannitol, xylitol, isomalt, and hydrogenated starch hydrolysates), ferrous or zero valent iron, or lime.

Stimulants can additionally include nitrogen sources such as urea or ammonium sulfate.

Embodiments of the treatment methods typically include applying an amendment containing a stimulant. A suitable amount of stimulant for the treatment of soil or sediment includes, but is not limited to, 0.5 to 2 pore volumes, or about 1 pore volume (i.e., 0.9 to 1.1 pore volume). While amounts greater than about 1 pore volume can be used, adding more than about 1 pore volume in a single amendment application is typically wasteful.

As used herein, “pore volume” refers to the volume of soil or sediment less the volume of the solid phase of the soil or sediment.

In embodiments of the method of treating, amendments can contain one or more stimulants in addition to other compounds such as, for example, one or more surfactants and/or shear-thinning polymers.

Suitable surfactants include, but are not limited to alfonic and polysorbate-type nonionic surfactants such as Tween® 20.

Suitable shear-thinning polymers include, but are not limited to, xanthan gum, locust bean gum, guar gum, cellulose gum, sodium alginate, tara gum, and SlurryPro™ CDP.

It can be desirable to apply compounds, for example, as part of the amendments, that allow an increase in the pH of the matter to be decontaminated to support and/or initiate alkaline hydrolysis. Accordingly, in the embodiments of the method of treating, the method can further comprise increasing the pH of the matter to be decontaminated by applying urea or an ammonium salt to raise the pH of the matter. Suitable ammonium salts include, but are not limited to, ammonium sulfate, ammonium chloride, ammonium acetate, or ammonium phosphate. For example, the pH of the matter can be raised to a pH from 8.5 to 10.5.

Amendments can be applied at the onset of treatment, periodically, or continuously, typically, until a desired degree of degradation has been achieved.

In a first aspect of the first embodiment or alternative first embodiment, the method is performed in situ. In a further aspect of the first embodiments or any of the foregoing aspects thereof, the matter is part of the vadose and/or saturated zone of a site to be decontaminated. In a further aspect of the first embodiments or any of the foregoing aspects thereof, the water is surface water and/or ground water. In a further aspect of the first embodiments or any of the foregoing aspects thereof, the stimulant is a liquid, solid, solution or suspension. In a further aspect of the first embodiments or any of the foregoing aspects thereof, the amendment is applied by injecting or permeating a solution and/or suspension containing the stimulant. In a further aspect of the first embodiments or any of the foregoing aspects thereof, the one or more energetic compounds occupy, independently, one or more compartments selected from 1) crystallized solid, 2) sorbed mass onto soil solids including organic matter and minerals, 3) diffused mass in low-permeability soil/sediment strata, and 4) dissolved mass in surface water, porewater or groundwater. In a further aspect of the first embodiments or any of the foregoing aspects thereof, the one or more energetic compounds are, independently, an explosive, a propellant, or an ignition compound. In a further aspect of the first embodiments or any of the foregoing aspects thereof, the one or more energetic compounds are, independently, 2,4,6-trinitrotoluene (TNT), 1,3,5-trinitro-1,3,5-triazinane (RDX), 1,3,5,7-tetranitro-1,3,5,7-tetrazocane (HMX), 1,3,5-trinitrobenzene (TNB), 1,3,5-triamino-2,4,6-trinitrobenzene (TATB), diazonitrophenol, nitroguanidine (NQ), 2,4-dinitroanisole (DNAN), tetryl and ammonium picrate (PA, AP), hexanitrohexaazaisowurtzitane (CL20), lead azide, diazodinitrophenol (DDNP), lead styphnate, tetracene, potassium dinitrobenzofuroxane (KDNBF), lead mononitroresorcinate (LMNR), fulminate, mercury styphnate, silver styphnate, pentaerythritol tetranitrate (PETN), 2,4-dinitrotoluene (DNT), 2,5-dinitrotoluene, 3,5-dinitrotoluene, 2,6-dinitrotoluene, 2-amino-4,6-dinitrotoluene, 4-amino-2,6-dinitrotoluene, methyl-2,4,6-trinitrophenyl nitramine (Tetryl), dinitroaniline, nitroglycerin (NG), nitrocellulose (NC), nitroguanidine, ammonium perchlorate, or potassium perchlorate. In a further aspect of the first embodiments or any of the foregoing aspects thereof, the matter contains a plurality of energetic compounds, and the method treats the plurality of energetic compounds. In a further aspect of the first embodiments or any of the foregoing aspects thereof, the matter contains a plurality of energetic compounds, and the method treats the plurality of energetic compounds simultaneously. In a further aspect of the first embodiments or any of the foregoing aspects thereof, the method further comprises further determining the temperature of the matter. In a further aspect of the first embodiments or any of the foregoing aspects thereof, comprising monitoring the amount of at least one of the one or more energetic compounds. In a further aspect of the first embodiments or any of the foregoing aspects thereof, the temperature is from 40° C. to 80° C. In a further aspect of the first embodiments or any of the foregoing aspects thereof, the temperature is from 40° C. to 60° C. In a further aspect of the first embodiments or any of the foregoing aspects thereof, the stimulant includes one or more of corn steep liquor, a volatile fatty acid, hydroxybenzoate, a monosaccharide, a disaccharide, a protein based carbon, cellobiose, cellulose, an amino acid, benzoate, molasses, whey, an oil, methane, ethane, ethene, hydrocarbons, nutrient broth/tryptone, a biopolymers, an alcohol, a sugar alcohol, ferrous or zero valent iron and lime. In a further aspect of the first embodiments or any of the foregoing aspects thereof, the method comprises applying a surfactant and/or shear-thinning polymer to the matter. In a further aspect of the first embodiments or any of the foregoing aspects thereof, the surfactant and/or shear-thinning polymer is part of the amendment and applied simultaneously with the stimulant. In a further aspect of the first embodiments or any of the foregoing aspects thereof, the applying of the amendment precedes the heating. In a further aspect of the first embodiments or any of the foregoing aspects thereof, the applying of the amendment is simultaneous to the heating. In a further aspect of the first embodiments or any of the foregoing aspects thereof, the heating precedes the applying of the amendment. In a further aspect of the first embodiments or any of the foregoing aspects thereof, the method further comprises applying urea or an ammonium salt to raise the pH of the matter. In a further aspect of the first embodiments or any of the foregoing aspects thereof, the ammonium salt is ammonium sulfate, ammonium chloride, ammonium acetate, or ammonium phosphate. In a further aspect of the first embodiments or any of the foregoing aspects thereof, the pH of the matter is increased to a value from 8.5 to 10.5.

When a range (e.g., from a first value to a second value; between a first value and a second value) is recited herein, the range is meant to include the recited first and second value, and all values therebetween.

### Examples

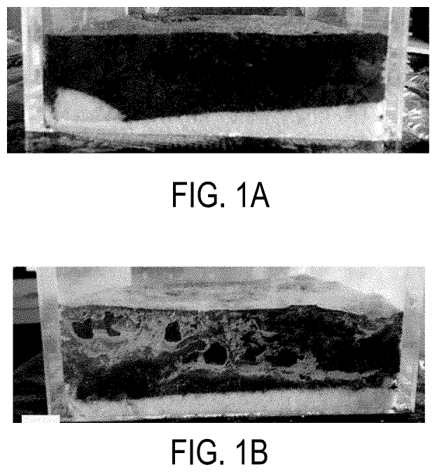

Experiments were conducted to demonstrate and further elucidate mechanisms and conditions and demonstrate accelerated treatment of energetic compounds, RDX and HMX, using heat-enhanced degradation with application of stimulants. Specifically, meso-scale microcosms were packed with a silty sand spiked with 50 milligrams per kilogram (mg/kg) each of the energetic compounds RDX (1,3,5-trinitro-1,3,5-triazinan) and HMX (1,3,5,7-tetranitro-1,3,5,7-tetrazocane) as shown in FIGS. 1A and 1B. Columns leached with rainwater and/or stimulant and run at either 20° C. or 40° C. Four amendment events (approximately 1.1 pore volume each) simulated infiltration and leaching with leachate collected for sampling and analysis.

Each microcosm experiment first consisted of saturating the soil with a rainwater control (no amendments and 10 millimolar (mM) calcium chloride [CaCl₂]) or various stimulation (enrichment) solutions (˜1.1 pore volumes) and covered with parafilm. The microcosm stimulation solutions comprised 100 mM sodium acetate, 0.5 g/L of corn steep liquor powder, 0.33 M urea or ammonium sulfate, and/or 0.5% (v/v) unsulfured molasses. After the pH in the test columns increased to between 8.5-9.0, a maintenance stimulation solution containing a reduced concentration of 50 mM sodium acetate and no molasses with all other amendment components being the same. In addition, 3 of the stimulation solutions were supplemented with 50 mM, 100 mM or 250 mM calcium chloride (CaCl₂). Table 2 provides a summary of the experiment operation and sampling. In addition to the enrichment solutions, each microcosm received three additional infiltration/injections of the maintenance solution. The effluent/leachate was collected after each infiltration event and tested as shown on Table 2. Effluent pH was monitored after application of the stimulation solution to monitor urea hydrolysis to ammonium, which resulted in a pH increase. At the conclusion of the experiments, composite samples from each microcosm were submitted for analysis to detect RDX and HMX remaining in the soils.

Tested conditions included running duplicate microcosms for each test condition and incubating the microcosm at either ambient (˜22° C.) or heated (40° C.) conditions as shown on Table 1.

TABLE 1
Experimental matrix

| | | 100 mM Sodium | | | | | 10 mM CaCl₂ |
|---|---|---|---|---|---|---|---|
| | | Acetate, 0.5 g | 0.333M | 0.333M | | | (simulated |
| Test condition | Temp. ° C. | CSL/L* | Urea | (NH4)2SO4 | CaCl₂ | | rain water) |
| Control 1-1 | 22 | | | | | | X |
| Control 1-2 | 40 | | | | | | X |
| Treatment #1 | 22 | X | X | | | | |
| Treatment #1 | 40 | X | X | | | | |
| Treatment #2 | 22 | X | | X | | | |
| Treatment #2 | 40 | X | | X | | | |
| Treatment #3 | 40 | X | X | | 50 | mM | |
| Treatment #4 | 40 | X | X | | 100 | mM | |
| Treatment #5 | 22 | X | X | | 250 | mM | |
| Treatment #5 | 40 | X | X | | 250 | mM | |

*First Stimulant Dosing also includes molasses (0.5% v/v)
C.—degree Celsius
CaCl₂—calcium chloride
CSL—corn steep liquor
L—liter
mM—millimolar
M—Molar

### Experimental Results

Results of the experiments were evaluated by assessing RDX and HMX concentrations in soil and leachate before, during and/or after treatment to determine the relative amount leached and in the soil. Dissolved concentrations were evaluated in leachate collected from the microcosms during the amendment events described in Table 2.

TABLE 2
Schedule and outline of experiments

| | | | | | | |
|---|---|---|---|---|---|---|
| | | | Treatment 2 | Treatment 3 | Treatment 4 | Treatment 5 |
| | | Treatment 1 | (Acetate, and | (Acetate, Urea, | (Acetate, Urea, | (Acetate, Urea, |
| | | (Acetate, | Ammonium | Calcium Chloride | Calcium Chloride | Calcium Chloride |
| Date | Negative Control | and Urea) | Sulfate) | (50 mM)) | (100 mM)) | (250 mM)) |

| | | | |
|---|---|---|---|
| Stimulation 1 | 1 | Saturate w/Rain | Saturate w/BS* |
| (Initial) | | | |
| Stimulation 2 | 2 | Saturate w/Rain | Saturate w/BC^{†} and Collect & Monitor ^{γ} |
| (Maintenance) | | | |
| Stimulation 3 | 3 | Saturate w/Rain | Saturate w/BC^{†} and Collect & Monitor ^{γ} |
| (Maintenance) | | | |
| Stimulation 4 | 4 | Saturate w/Rain | Saturate w/BC^{†} and Collect & Monitor ^{γ} |
| (Maintenance) | | | |

| | | |
|---|---|---|
| Post-Treatment | 5 | Composite soil samples were collected and sent for final analysis and mass balance. |
| Soil test | | |

*BS = Stimulation Solution (Initial) with 100 mM acetate and molasses
^{†}BC = Stimulation Solution (Maintenance) with 50 mM acetate and no molasses
^{γ} Analytes to be monitored volume, pH, ammonia, total organic carbon, anions, alkalinity, Energetics and Daughter Products
Note:
Date 1 = day 1; Date 2 = day 8; Date 3 = day 15; Date 4 = day 22; Date 5 = day 29.

The total mass originally loaded in the soils was then compared to the mass removed during leaching and the total mass remaining in the soil post-testing. The negative controls were used to compare the impact of the leaching on total mass as the basis for comparison to both the microcosms treated with amendments at ambient temperature and treated with amendments at elevated temperature.

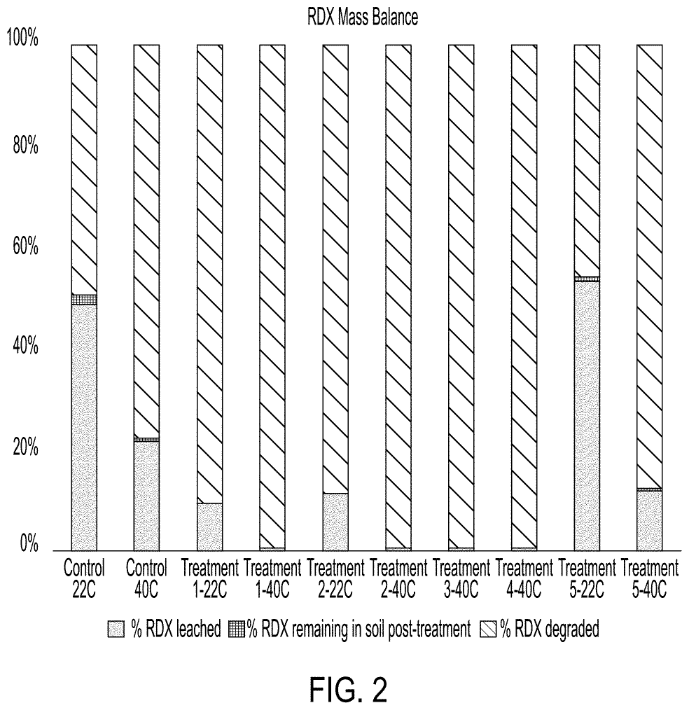

Table 3 and FIG. 2 present results of the total amount of RDX leached from the microcosms, remaining on the soil post-treatment and degraded over the course of the study. The microcosms in Treatments 1, 2, 3 and 4 at 40° C. observed a 99-100% reduction in total RDX compared with a 49% and 78% reduction in the controls and a 89-91% reduction at ambient temperature (22° C.).

TABLE 3
Final mass balance for RDX

| | Original mass of | Final Mass Balance | | |
|---|---|---|---|---|
| | RDX in | Non-degraded | | |
| | Microcosms (μg) | RDX (μg) | % Non-degraded RDX | % RDX degraded |
| | Jul. 17, 2018 | Aug. 22, 2018 | Aug. 22, 2018 | Aug. 22, 2018 |
| Control 22 C. | 20511 | 10360 | 51% | 49% |
| Control 40 C. | 20508 | 4577 | 22% | 78% |
| Treatment 1-22 C. | 20480 | 1923 | 9% | 91% |
| Treatment 1-40 C. | 20495 | 120 | 1% | 99% |
| Treatment 2-22 C. | 20517 | 2323 | 11% | 89% |
| Treatment 2-40 C. | 20533 | 144 | 1% | 99% |
| Treatment 3-40 C. | 20532 | 128 | 1% | 99% |
| Treatment 4-40 C. | 20480 | 101 | 0% | 100% |
| Treatment 5-22 C. | 20534 | 11154 | 54% | 46% |
| Treatment 5-40 C. | 20502 | 2538 | 12% | 88% |

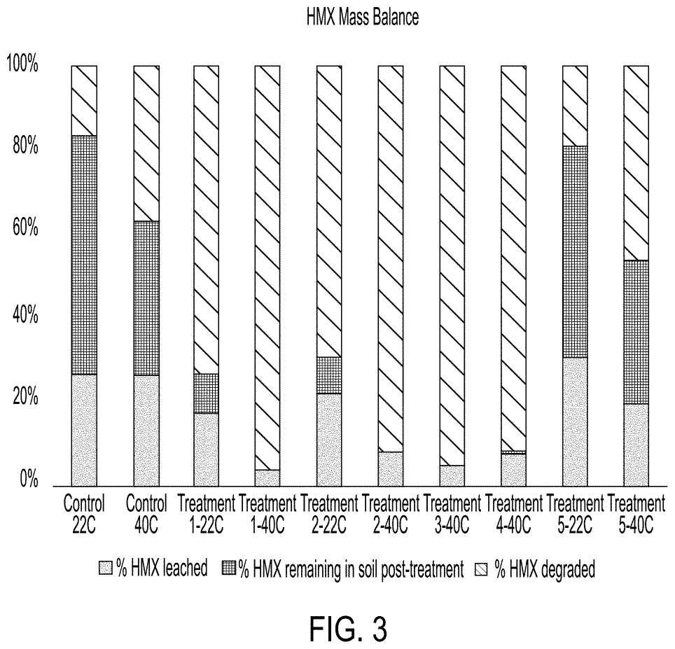

Table 4 and FIG. 3 present results of the total amount of HMX leached from the microcosms, remaining in the soil post-treatment and degraded over the course of the study. The microcosms in Treatments 1, 2, 3 and 4 at 40° C. observed a 92-96% reduction in total HMX mass degraded compared with a 17% and 37% reduction in the controls and a 69-73% reduction at ambient temperature (22° C.).

TABLE 4
Final mass balance of HMX (best performing)

| | Original mass of | Final Mass Balance | | |
|---|---|---|---|---|
| | HMX in | Non-degraded | | |
| | Microcosms (μg) | HMX (μg) | % Non-degraded HMX | % HMX degraded |
| | Jul. 17, 2018 | Aug. 22, 2018 | Aug. 22, 2018 | Aug. 22, 2018 |
| Control 22 C. | 22012 | 18346 | 83% | 17% |
| Control 40 C. | 22008 | 13806 | 63% | 37% |
| Treatment 1-22 C. | 21978 | 5861 | 27% | 73% |
| Treatment 1-40 C. | 21994 | 876 | 4% | 96% |
| Treatment 2-22 C. | 22018 | 6750 | 31% | 69% |
| Treatment 2-40 C. | 22035 | 1778 | 8% | 92% |
| Treatment 3-40 C. | 22034 | 1078 | 5% | 95% |
| Treatment 4-40 C. | 21978 | 1843 | 8% | 92% |
| Treatment 5-22 C. | 22036 | 17761 | 81% | 19% |
| Treatment 5-40 C. | 22003 | 11812 | 54% | 46% |

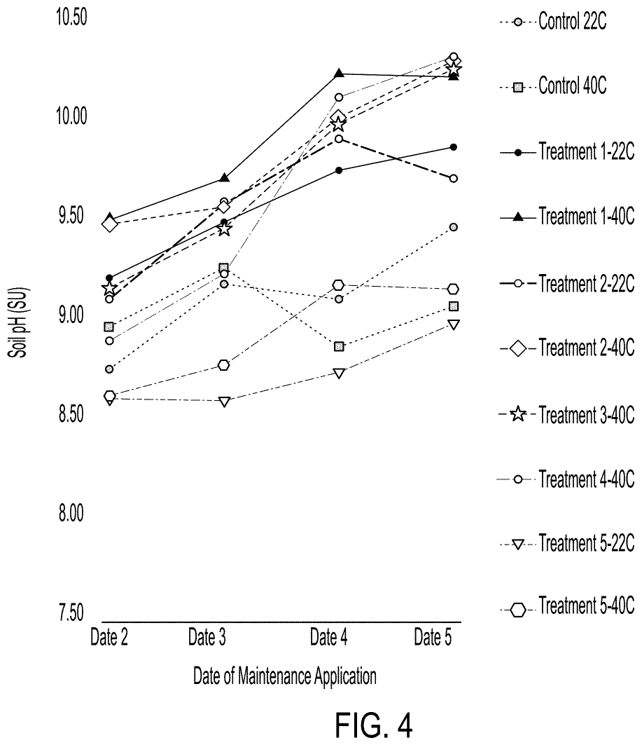

Soil pH exhibited a general increasing trend over the course of the experiment in some cases exceeding pH 10 (see FIG. 4). In addition, Treatments 1, 2, 3, and 4 at 40° C. had a higher pH than the other treatments. Alkaline hydrolysis is likely occurring in microcosms with higher soil pHs.

This observed increase in pH is desired, because it likely initiates alkaline hydrolysis. The increase in pH is due to (1) urea hydrolysis, which liberates ammonia from urea (and deposits carbonates) or (2) the addition of ammonium sulfate. The urea hydrolysis is biologically mediated. The increase in pH due to ammonium sulfate is a chemical reaction. Additionally, some increase in pH is due to decomposition of the amino groups in the biomass which also results in the release of ammonia.

The series of experiments demonstrated that a significant increase in RDX and HMX degradation was realized with a combination of stimulation with amendments containing carbon, nitrogen and/or trace minerals/amino acids to rapidly degrade both HMX and RDX in soils at 40° C. The best performing tests degraded 99-100% of RDX and 95-96% of HMX in situ after one stimulation application and three maintenance applications given over the period of 29 calendar days.

The relevant teachings of all patents, published applications and references cited herein are incorporated by reference.

While example embodiments have been particularly shown and described, it will be understood by those skilled in the art that various changes in form and details may be made therein without departing from the scope of the embodiments encompassed by the appended claims.

What is claimed is:

1. A method for treating matter from a contaminated site in need of decontamination, comprising (i) applying an amendment containing a stimulant to the matter, and (ii) actively heating the matter in a controlled manner such that the matter has a temperature above ambient and below 100° C., wherein the matter is contaminated with one or more energetic compounds.

2. The method of claim 1, wherein the method is performed in situ.

3. The method of claim 1, wherein the matter is part of the vadose and/or saturated zone of a site to be decontaminated.

4. The method of claim 1, wherein the matter is surface water or ground water.

5. The method of claim 1, wherein the stimulant is a liquid, solid, solution or suspension.

6. The method of claim 1, wherein the amendment is applied by injecting or permeating a solution and/or suspension containing the stimulant.

7. The method of claim 1, wherein the one or more energetic compounds occupy, independently, one or more compartments selected from 1) crystallized solid, 2) sorbed mass onto soil solids including organic matter and minerals, 3) diffused mass in low-permeability soil/sediment strata, and 4) dissolved mass in surface water, porewater or groundwater.

8. The method of claim 1, wherein the one or more energetic compounds comprise an explosive, a propellant, or an ignition compound.

9. The method of claim 1, wherein the one or more energetic compounds are independently selected from 2,4,6-trinitrotoluene (TNT), 1,3,5-trinitro-1,3,5-triazinane (RDX), 1,3,5,7-tetranitro-1,3,5,7-tetrazocane (HMX), 1,3,5-trinitrobenzene (TNB), 1,3,5-triamino-2,4,6-trinitrobenzene (TATB), diazonitrophenol, nitroguanidine (NQ), 2,4-dinitroanisole (DNAN), tetryl and ammonium picrate (PA, AP), hexanitrohexaazaisowurtzitane (CL20), lead azide, diazodinitrophenol (DDNP), lead styphnate, tetracene, potassium dinitrobenzofuroxane (KDNBF), lead mononitroresorcinate (LMNR), fulminate, mercury styphnate, silver styphnate, pentaerythritol tetranitrate (PETN), 2,4-dinitrotoluene (DNT), 2,5-dinitrotoluene, 3,5-dinitrotoluene, 2,6-dinitrotoluene, 2-amino-4,6-dinitrotoluene, 4-amino-2,6-dinitrotoluene, methyl-2,4,6-trinitrophenyl nitramine (Tetryl), dinitroaniline, nitroglycerin (NG), nitrocellulose (NC), nitroguanidine, ammonium perchlorate, and potassium perchlorate.

10. The method of claim 1, wherein the matter contains a plurality of energetic compounds, and the method treats the plurality of energetic compounds.

11. The method of claim 10, wherein the plurality of energetic compounds is treated simultaneously.

12. The method of claim 1, further comprising determining the temperature of the matter.

13. The method of claim 1, further comprising monitoring the amount of at least one of the one or more energetic compounds.

14. The method of claim 1, wherein the temperature is from 20° C. to 100° C.

15. The method of claim 1, wherein the stimulant includes one or more of corn steep liquor, a volatile fatty acid, hydroxybenzoate, a monosaccharide, a disaccharide, a protein based carbon, cellobiose, cellulose, an amino acid, benzoate, molasses, whey, an oil, methane, ethane, ethene, hydrocarbons, nutrient broth/tryptone, a biopolymers, an alcohol, a sugar alcohol, ferrous or zero valent iron and lime.

16. The method of claim 1, further comprising applying a surfactant and/or shear-thinning polymer to the matter.

17. The method of claim 16, wherein the surfactant and/or shear-thinning polymer is part of the amendment and applied simultaneously with the stimulant.

18. The method of claim 1, wherein the applying of the amendment precedes the heating.

19. The method of claim 1, wherein the applying of the amendment is simultaneous to the heating.

20. The method of claim 1, wherein the heating precedes the applying of the amendment.

21. The method of claim 1, further comprising applying urea, an ammonium salt, or lime to raise the pH of the matter.

22. The method of claim 21, wherein the ammonium salt is ammonium sulfate, ammonium chloride, ammonium acetate, or ammonium phosphate.

23. The method of claim 21, wherein the pH of the matter is increased to a value from 8.5 to 10.5.

24. A method for treating contaminants in or from a contamination site comprising (1) applying an amendment containing a stimulant to the contaminants and (ii) actively heating the contaminants in a controlled manner such that the contaminants have a temperature above ambient, and below 100° C., wherein the contaminants are energetic compounds.
